(19) United States
(12) Patent Application Publication
(10) Pub. No.: US 2003/0048227 A1
(43) Pub. Date: Mar. 13, 2003

(54) Portable radio equipment capable of receiving signals of multiple frequency bands

(75) Inventor: Shinya Nakamura, Saitama (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/223,352

(22) Filed: Aug. 20, 2002

(30) Foreign Application Priority Data
Sep. 13, 2001 (JP) 277849/2001

(51) Int. Cl. H01Q 1/24

(52) U.S. Cl. 343/702; 343/700 MS

(57) ABSTRACT

A portable radio equipment using multiple frequency bands for communication is provided with a rod-shaped first antenna which can be extended or contracted. A second antenna used for a second frequency band is built. The first antenna is independently matched in one frequency band by a matching circuit, it can be matched when the first antenna is housed and when it is extended.

### BACKGROUND OF THE INVENTION

1. Field of the Invention

The present invention relates to portable radio equipment, and in particular relates to portable radio equipment in which multiple different frequency bands are used and there is no difference in characteristics in a rod-shaped antenna between when it is extended and when it is housed.

2. Description of the Related Art

Portable radio equipment such as mobile telephones generally has a structure that is an extensible antenna that is attached to the body. For an antenna used for portable radio equipment, there are various types. Typically, a wideband whip antenna and a helical antenna are used.

FIG. 1 shows conventional type portable radio equipment. FIG. 1 shows an antenna mounted part in the body of portable radio equipment 10 and a printed board 2 is built in the body 1. A whip antenna 3 used for send and receive is attached on the printed board 2 in addition to send and receive circuits (not shown). The whip antenna 3 can be extended or contracted and can be housed in the body 1 when the portable radio equipment 10 is not used. When the portable radio equipment 10 is carried, the whip antenna 3 is housed in the body 1 and only in when sending/receiving transmission, it is pulled out of the body 1 and is extended. Therefore, as the protrusion from the body 1 of the whip antenna 3 can be reduced when the portable radio equipment 10 is not used, the portable radio equipment has excellent portability. However, as the portable radio equipment 10 is next to an ear, the gain of the whip antenna 3 is deteriorated because of the effect of the human body. Therefore, the quality of conversation may be deteriorated when the whip antenna is receiving weak signals. Then, if the whip antenna 3 is used in a state in which it is extended to its maximum length in order to increase its gain, satisfactory conversation quality can be acquired.

FIG. 1 shows a state that the whip antenna 3 is contracted and the whole is housed in the body 1. A feeding part in housing 4 is connected to the whip antenna 3 via a matching circuit 5 and a transmitter-receiver 9 is connected to the matching circuit 5. In the meantime, when the whip antenna 3 is extended, a feeding part in extension 6 is connected to the whip antenna 3 via the matching circuit 5 similarly to the case of the feeding part in housing 4. As described above, both in the extension and in the housing of the antenna, the common matching circuit 5 is generally used. Therefore, the structure and the dimensions of the whip antenna 3 are determined so that the impedance Zin of the independent antenna of this type of portable radio equipment 10 is substantially equal in extension and in housing, and sending and receiving messages without hindrance are enabled in extension and in housing.

However, recently, multiband portable radio equipment having multiple frequency bands has been used. Then, if the antenna that can be extended and housed as described above is used in multiband portable radio equipment, the multiband portable radio equipment has excellent portability and the quality of conversation can be acquired.

FIG. 2A is Smith chart in case a value of a matching circuit is included in a calculated value of the impedance characteristic of a rod-shaped or linear antenna, that is, a whip antenna and FIG. 2B shows a characteristic of return loss (RL). FIG. 3A is Smith chart in case a value of the same matching circuit as the matching circuit in the case of the whip antenna is included in the impedance characteristic by calculation of a helical antenna and FIG. 3B shows a characteristic of return loss (RL). It is desirable that the characteristics of return loss (RL) shown in FIGS. 2B and 3B have a characteristic that drops in a minus direction in a used frequency band (in these cases, in a band of 800 MHz and a band of 1.6 GHz).

As clear from FIGS. 3A and 3B, the helical antenna is matched in both bands of the band of 800 MHz and the band of 1.6 GHz. In the meantime, as shown in FIGS. 2A and 2B, the whip antenna is matched in the band of 800 MHz and shows a more satisfactory characteristic than the helical antenna, however, the whip antenna is hardly matched in the band of 1.6 GHz. The reason is that difference between when the whip antenna is housed and when it is extended is large in the band of 1.6 GHz though the impedance when the whip antenna is housed is substantially coincident with the impedance when the whip antenna is extended in the band of 800 MHz.

In case the helical antenna is used, the impedance can be matched in both of the band of 800 MHz and the band of 1.6 GHz as shown in FIGS. 3A and 3B, however, in the band of 800 MHz, the characteristic is inferior to that of the whip antenna and the deterioration of the gain occurs. For the helical antenna, as the diameter of a helical part is large in the structure, it is difficult to house the whole antenna in the body 1 and there is a constraint on the design of the body. Then, it is proposed that a matching circuit for embodying the characteristic of the whip antenna that a satisfactory characteristic is acquired when the whip antenna is extended and the characteristic of the helical antenna excellent in a high-frequency band when the helical antenna is housed in one antenna is provided.

However, in conventional type portable radio equipment, it is extremely difficult to equalize the levels of impedance characteristics when the whip antenna is extended and when it is housed for multiple frequency bands. Thus, mismatching to some extent is allowed and deterioration of the gain is inevitable, and the shortage of receiving sensitivity and the impossibility of communication may be caused.

A method of detecting whether an antenna is extended or housed and changing a state of a matching circuit according to the result of the detection and a used frequency band is conceivable. However, the circuit configuration is complex, the number of parts of the matching circuit is increased, securing mounting space is difficult and the cost is increased. Losses due to a switching circuit are also caused.

### SUMMARY OF THE INVENTION

An aspect of the present invention is to solve the above-mentioned problems and provide a portable radio equipment using multiple frequency bands, which is matched in any frequency band and further, in which no difference is made between characteristics when a rod-shaped antenna is extended and when it is housed.

To solve the above mentioned problem, a portable radio equipment of the present invention comprises a first receiving circuit that receives a first signal within a first frequency band, and a second receiving circuit that receives a second signal within a second frequency band. The portable radio equipment further comprises a first antenna that is used for transmitting a third signal within the first frequency band. The first antenna can be housed in the body of the portable radio equipment and becomes the shape of a rod when extended. The portable radio equipment further comprises a second antenna that is used for transmitting a fourth signal within the second frequency band, and arranged inside the body of the portable radio equipment is used. The portable radio equipment further comprises a first matching circuit that is coupled to the first antenna and a second matching circuit that is coupled to the second antenna and is different from the first matching circuit. The portable radio equipment may further comprise a switching circuit that switches between the first matching circuit and the second matching circuit. The switching circuit is preferably switched on the basis of a received signal. The first antenna is housed in the vicinity of an earphone in the body. The first matching circuit may also be housed in the vicinity of an earphone in the body. The first antenna is a whip antenna. The second antenna is mounted within the portable radio equipment itself. The second antenna is arranged in the vicinity of a microphone in the portable radio equipment. The second matching circuit may also be arranged in the vicinity of a microphone in the portable radio equipment. The second antenna is any one of a plane parallel antenna, a helical antenna, a microstrip-type, a loaded-type, a helical-type, an inverted-L-type, a top-loaded-type or a dielectric-coated-type antenna. The portable radio equipment is preferably a portable telephone.

In accordance with the present invention, the first antenna is used for the first frequency band, and most of the first antenna is housed within the body of the portable radio equipment. The first antenna becomes the shape of a rod when extended. The second antenna is used for the second frequency band, which may be higher than the first frequency band. The second antenna is arranged in the body of the portable radio equipment in a portion apart from the human body when the portable radio equipment is used. Only one antenna has only to be matched in one frequency band, and portable radio equipment using multiple frequency bands can be achieved. The best matching in which a high gain is acquired in any frequency band is acquired and for the first antenna, both when the antenna is extended and when it is housed, and matching is enabled.

### BRIEF DESCRIPTION OF THE DRAWINGS

These and other aspects, features and advantages of the invention will become more fully apparent from the following detailed description taken in conjunction with accompanying drawings. In the drawings:

FIG. 1 is a perspective view schematically showing related type portable radio equipment;

FIG. 2A is Smith chart and shows characteristics in case a value of a matching circuit is included in a calculated value of the impedance characteristic of a whip antenna;

FIG. 2B shows a characteristic of return loss of the whip antenna;

FIG. 3A is Smith chart and shows characteristics in case a value of a matching circuit is included in a calculated value of the impedance characteristic of a helical antenna;

FIG. 3B shows a characteristic of return loss of the helical antenna;

FIG. 4 is a perspective view schematically showing portable radio equipment according to the invention;

FIG. 5 is a block diagram showing the schematic configuration of an electric system of the portable radio equipment according to the invention; and

FIG. 6 is an explanatory drawing showing positional relation between the portable radio equipment according to the invention while used and a human body.

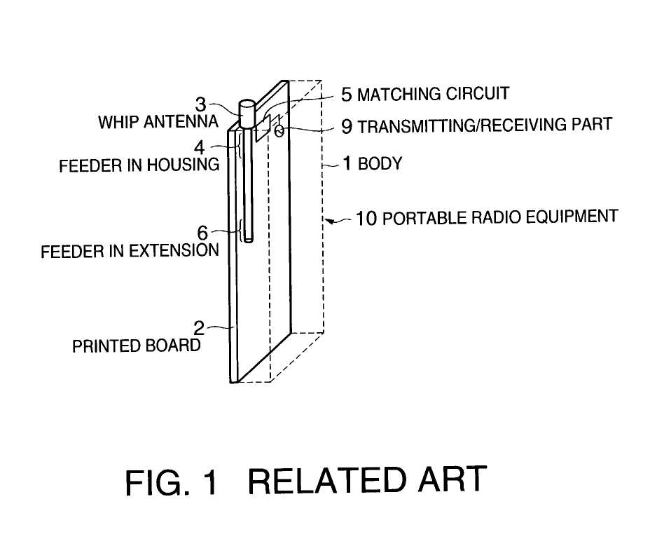

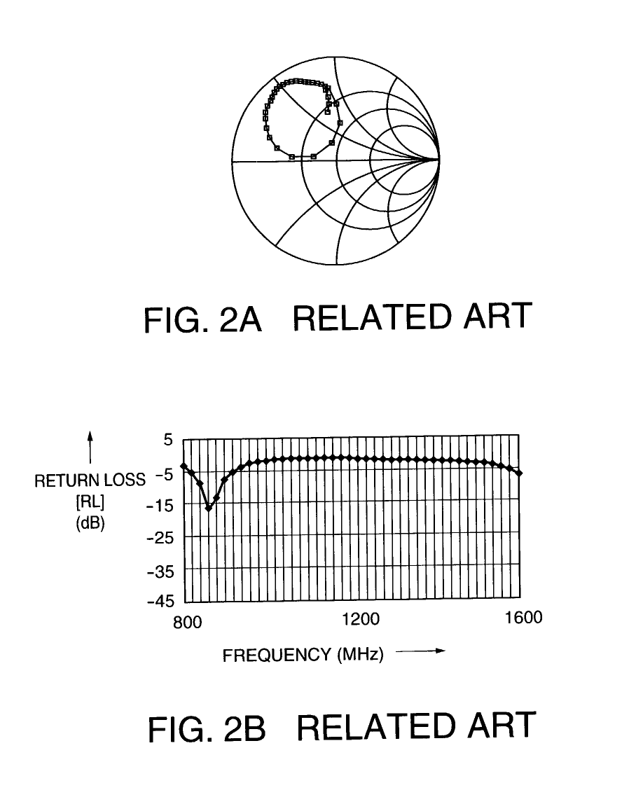

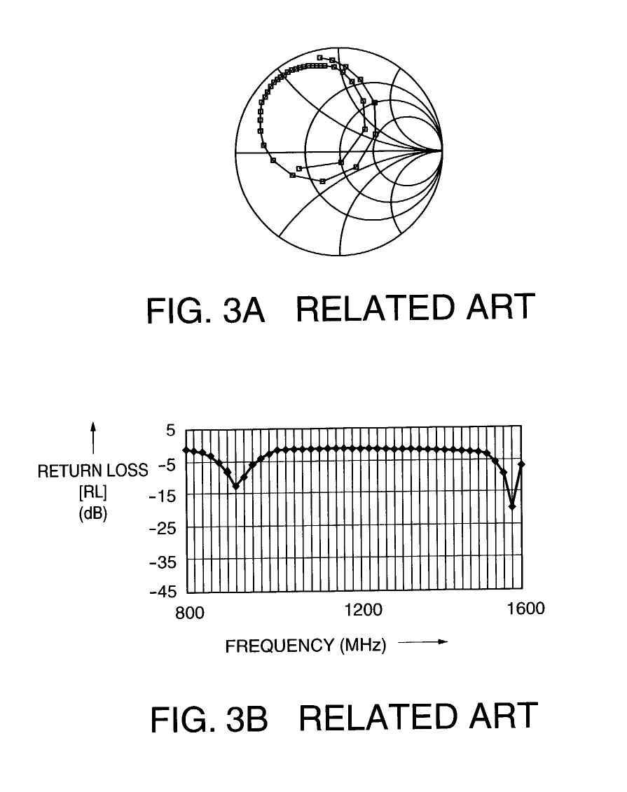

### DETAILED DESCRIPTION OF THE EMBODIMENTS

Hereinafter, each embodiment of the present invention will be described in detail with reference to the drawings.

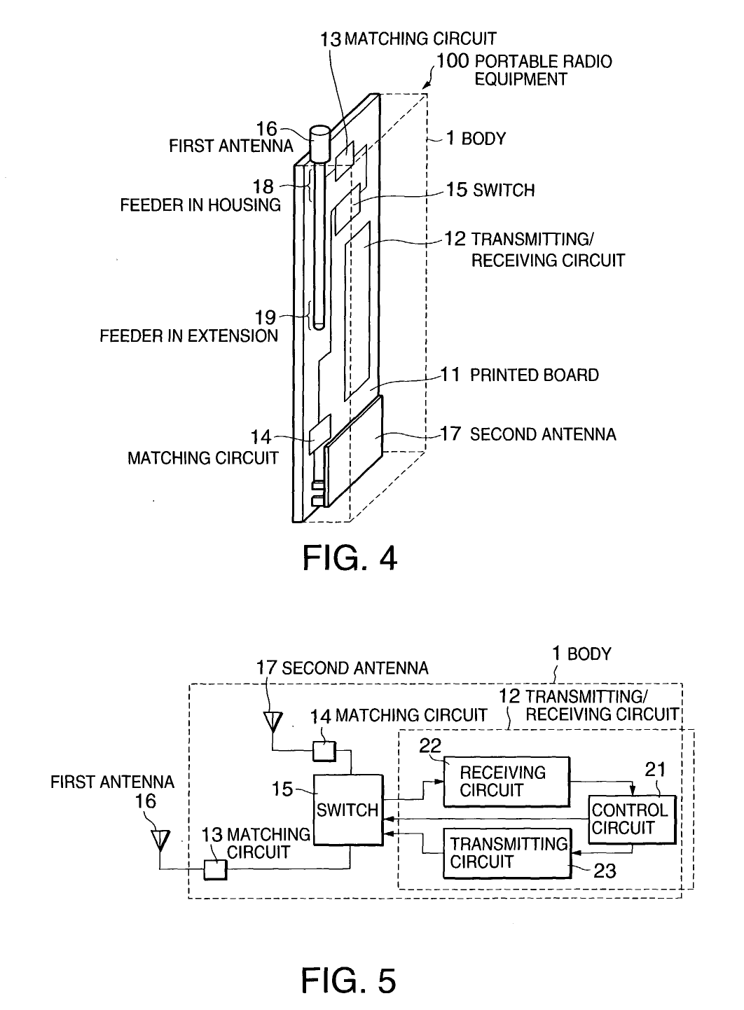

FIG. 4 schematically shows portable radio equipment according to the invention. For the portable radio equipment, portable radio equipment corresponding to a dual band system will be described below.

A printed board 11 is arranged in the body 1 of portable radio equipment 100 (a keyboard, a liquid crystal display, function keys, a microphone, a receiver are not shown). On the printed board 11, a transmitting/receiving circuit 12, matching circuits 13, 14, a switch 15 for switching these matching circuits, a first antenna 16 used for communication in a low frequency band (in this case, in a band of 800 MHz) and a second antenna 17 used for communication in a high frequency band (in this case, in a band of 1.6 GHz) are provided.

The matching circuit 13 is connected to the first antenna 16, the matching circuit 14 is connected to the second antenna 17 and the switch 15 is connected to these matching circuits 13, 14. Impedance among the first antenna 16, the second antenna 17 and the transmitting/receiving circuit 12 is matched by the matching circuits 13, 14. The matching circuit 13 has only to match with only the band of 800 MHz for the first antenna 16 and the matching circuit 14 has only to match with only the band of 1600 MHz for the second antenna 17. Therefore, for the first antenna, both when it is extended and when it is contracted, a high gain is acquired.

For example, for the first antenna 16, a whip antenna is suitable. Or a rod-shaped antenna having structure in which at only the end, a helical part is provided and as a whole, extension/housing is enabled can be used. For the second antenna 17, a plane parallel type (an inverted F type, a microstrip antenna and so on), a loaded type, a helical type, an inverted L type, a top-loaded type and a dielectric-coated type can be used. However, since the second antenna is completely built in the body 1, this type is excellent in performance, is compact and does not require large space is desirable.

As described above, any frequency band can be matched in the best state by using two antennas of the whip antenna that can be extended and housed (a multistage type or merely structure that the whole can be pulled in) for the first antenna 16 and the second antenna 17 built in the body 1. This enables the use of plural different frequency bands. Since the whip antenna that can be housed and extended is used for the first antenna 16, the first antenna has the same appearance as that of the conventional type. Thus, a user feels no sense of incompatibility and the mounting space in the body is similar to that of the conventional type. Since the frequency band of the second antenna 17 is high, the size of the second antenna 17 can be reduced and it fits well within inside mounting space and does not obstruct the mounting of other parts.

The first antenna 16 is arranged in the upper part of the body 1 and on the right side or on the left side of the body 1. When it is housed, only the end is exposed from the body 1 and overall most is exposed from the body 1 by pulling out the end with fingers. In case the first antenna 16 is installed at the height of a receiver, the first antenna 16 when it is extended can be separated from a human body (the head) and while the first antenna is used, it also obstructs nothing. For the first antenna 16, a feeder is formed in different parts when the first antenna is housed and when it is extended, a feeder in housing 18 is formed in housing and a feeder in extension 19 is formed in extension.

The second antenna 17 is arranged in the vicinity of the microphone (not shown) in the body 1. In its installed position, since the position of the portable radio equipment 100 grasped with a hand of a user is equivalent to the center in the height of the portable radio equipment, the second antenna 17 is not overlapped with (does not approach) the hand. Therefore, the user's hand does not interfere with the second antenna 17 and therefore, a high gain is acquired.

FIG. 5 shows the schematic configuration of the portable radio equipment 100 according to an embodiment of the invention. In the body 1, as described in relation to FIG. 4, the matching circuits 13, 14, the switch 15 and the transmitting/receiving circuit 12 are built. The transmitting/receiving circuit 12 is provided with a control circuit 21 that controls the whole portable radio equipment. A receiving circuit 22 is connected to the control circuit 21 and the switch 15 for amplifying and demodulating a signal received by the antenna 16 or 17. A transmitting circuit 23 is connected to the control circuit 21 and the switch 15, and generates the sending power of a predetermined frequency and outputs this to the antenna 16 or 17.

In the configuration shown in FIG. 5, the control circuit 21 switches the antennas 16 and 17. A signal related to the assignment of a frequency band sent from a partner of the portable radio equipment 100 is received in the receiving circuit 22 and is passed to the control circuit 21. The control circuit 21 controls the switch 15 according to the signal related to the assignment of the frequency band from the receiving circuit 22 and selects specified one of the first and second antennas 16 and 17.

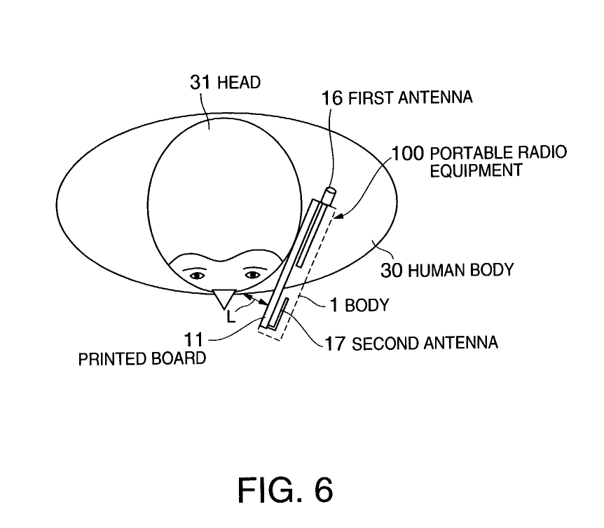

FIG. 6 shows positional relation between the portable radio equipment 100 and a human body (a user) 30. While the portable radio equipment is used, the upper part of the portable radio equipment 100 is touched to an either ear of the head 31 and the portable radio equipment 100 is grasped by the user so that an interval L is formed between the mouth and the microphone. Therefore, the second antenna 17 is separated from the human body 30 (or the head 31) and the electromagnetic signals hardly have an effect upon the human body 30. While the portable radio equipment is used, the extended first antenna 16 is usually tilted along the contour of the user's face and the whole portable radio equipment 100 is naturally tilted along the head 31. Therefore, the upper end of the first antenna 16 is fully separated from the head 31 and an electromagnetic wave hardly has an effect upon the human body 30.

As described above, according to the embodiment, as two frequency bands are shared between the first antenna 16 and the second antenna 17, multiband portable radio equipment in which two frequency bands can be set in the best matched state can be acquired. Further, as the second antenna 17 that undertakes a higher frequency band can be small-sized, it does not affect mounting volume in the body 1 even if the second antenna is built in the body 1. Particularly, as predetermined distance can be made between the human body (concretely, the hand) and the second antenna 17 by mounting the second antenna 17 close to the microphone, matching in which a high gain is acquired in two frequency bands is enabled. Particularly, for the first antenna 16, both when it is housed and when it is extended, matching is enabled.

In the embodiment, the portable radio equipment 100 is a mobile telephone; however, it can be applied to all portable radio equipment using multiple different frequency bands and the invention can be also applied to operational radio equipment, various mobile radio equipment and a personal handyphone system (PHS).

Obviously, numerous additional modifications and variations of the present invention are possible in light of the above teachings. It is, therefore, to be understood that within the scope of the appended claims, the invention may be practiced otherwise than as specifically described herein.

What is claimed is:

1. A portable radio equipment, comprising:
a first receiving circuit that receives a first signal within a first frequency band;
a second receiving circuit that receives a second signal within a second frequency band;
a first antenna that is used for transmitting a third signal within said first frequency band, wherein a portion of said first antenna is housed within said portable radio equipment, and which becomes the shape of a rod when said first antenna is extended; and
a second antenna that is used for transmitting a fourth signal within said second frequency band, and arranged in a portion of said portable radio equipment.

2. The portable radio equipment as claimed in claim 1, further comprising:
a first matching circuit coupled to said first antenna; and
a second matching circuit coupled to said second antenna.

3. The portable radio equipment as claimed in claim 2, further comprising a switching circuit that switches between said first matching circuit and said second matching circuit.

4. The portable radio equipment as claimed in claim 3, wherein said switching circuit is switched on the basis of a received signal.

5. The portable radio equipment as claimed in claim 4, wherein said first antenna is housed in the vicinity of an earphone in the body.

6. The portable radio equipment as claimed in claim 5, wherein said first matching circuit is also housed in the vicinity of an earphone in the body.

7. The portable radio equipment as claimed in claim 6, wherein said first antenna is a whip antenna.

8. The portable radio equipment as claimed in claim 2, wherein said second antenna is mounted inside said portable radio equipment itself.

9. The portable radio equipment as claimed in claim 8, wherein said second antenna is arranged in the vicinity of a microphone in said portable radio equipment.

10. The portable radio equipment as claimed in claim 9, wherein said second matching circuit is also arranged in the vicinity of said microphone in said portable radio equipment.

11. The portable radio equipment as claimed in claim 10, wherein second antenna is any one of a plane parallel antenna, a helical antenna, a microstrip-type, a loaded-type, a helical-type, an inverted-L-type, a top-loaded-type or a dielectric-coated-type antenna.

12. The portable radio equipment as claimed in claim 1, wherein said portable radio equipment is a portable telephone.

13. The portable radio equipment as claimed in claim 1, wherein said second frequency band is higher than said first frequency band.

14. The portable radio equipment as claimed in claim 2, wherein said second matching circuit has different matching characteristics from said first matching circuit.

15. The portable radio equipment as claimed in claim 3, further comprising a control circuit that controls said switching circuit.
